(19) United States
(12) Patent Application Publication
(10) Pub. No.: US 2024/0120755 A1
(43) Pub. Date: Apr. 11, 2024

(54) One way charging safety cable for bag or luggage

(71) Applicant: Li Zhijian, Fujian (CN)

(72) Inventor: Li Zhijian, Fujian (CN)

(21) Appl. No.: 18/539,514

(22) Filed: Dec. 14, 2023

(30) Foreign Application Priority Data
Nov. 18, 2014 (CN) 201420692148.1
Aug. 20, 2015 (CN) 201520737260.7

(51) Int. Cl. H02J 7/00; A45C 15/00; A45F 3/04

(52) U.S. Cl. CPC H02J 7/0042; A45C 15/00; A45F 3/04; H02J 7/00034; H02J 7/00302; H02J 7/00309; H01R 13/6675

(57) ABSTRACT

A one way safety charging cable for bag and luggage having a bag or luggage body, a cable with at least one male connector and at least one female connector, a sheath fixed on the body to receive the female connector of the cable, and retained above the outer surface of the body, wherein the male connector is retained inside of the body adjacent to a power source placing space, wherein inside of the male connector there are at least 4 Diodes, forming a special one way cable for output non input function to avoid the risk of overcharging and overheating of the power source inside of the body.

### TECHNICAL FIELD

The present invention model relates to a one way charging cable for bag and luggage for the purpose of safety use, the bag or luggage comprising a charging port on it's body for a power supply storage and for convenient charging personal devices such as smart phones, tablets or any device that requires recharging, without taking out the power supply. And not allowed to input charging the power supply through this cable to prevent the power supply in the bag or luggage become over heating to reduce the risk of power source/battery explosion.

### BACKGROUND OF THE INVENTION

With the constant development of our society, diverse portable digital devices are emerging in our lives, and we rely more and more on them, including tablet computers, cellphones, digital cameras, video cameras and the like. In addition to containing the stuff, people want more functionality from the bags and luggage. For example, charging the portable digital devices. Especially for tourists, field staff and those making long-term business trips, it is not easy to charge their digital devices when the power source/battery is dying, causing a lot of inconvenience and trouble in their works and lives. The cable build in the bag or luggage according to the present invention allows for bags, luggage, clothing, activewear and anything wearable or carried to be equipped with a charging function, or a portable power source. It is no longer necessary to open the bag, luggage or clothing for charging, which is convenient. In view of the inflammable and explosive characteristics of the power source/battery, it should not be charged in a relatively closed small space (such as inside of bag/pocket). In order to avoid the non-standard operation of consumers, the power source/battery inside the bag is charged by the charging cable build-in the bag or luggage, which may cause the risk of overheating and explosion of the power source/battery. In particular, the patented product of one way changing cable for bag or luggage is further innovated.

### SUMMARY OF THE INVENTION

The present invention intends to overcome the disadvantages stated above, and provides a one way charging cable that may be incorporated into luggage, bags, gloves, activewear, jacket, socks, shoes, hats, glasses, goggles, belts or anything wearable or that can be carried for convenient charging, which enables the user to charge a device or product needing to be charged conveniently at any time or any place during traveling, without necessarily opening the bag, luggage, or clothing nor taking out the power source for charging. But no way to input power into the power source/battery through the one way charging cable to the power source/power inside of the bag or luggage. The term “body” can also refers to any suitable base that the cable may be attached to for easy charging, including, without limitation a bag, luggage, clothing, activewear, shoes, hats, glasses, belt or anything wearable or that can be carried.

The present invention is realized in the following way an one way charging cable, comprising: a bag or luggage body, a cable with at least one male connector and one female connector, a sheath fixed on the body to receive the female connector of the cable, and retained above the outer surface of the body, wherein, the male connector in retained inside of the body, adjacent to a power source placing space, wherein, inside of the male connector, comprising a pull-down resistor in regular standard of around 56 KΩ, and a pull-up resistor in between 4.5 kΩ and 12 KΩ, and at least 4 Diodes, forming a special one way cable for output non input function, to avoid the risk of overcharging and overheating of the power source inside of the body.

During traveling, when the battery of consumer's devices to be charged is dying, it is only necessary to plug the charging interface of the device to be charged into the female end of the cable connector, then the charging starts, without necessarily opening the bag or luggage, nor taking out the power source for charging. But never available to charge the power source inside of the bag or luggage through this one way charging cable.

An one way charging cable for bag and luggage using for the purpose of safety use, the female connector comprising an regular USB output port and/or a type C output port. The regular USB output port and the type C output port are settled in one female connector, and their distance is at least 1 mm. The female connector is in a shape and sizes matching the sheath on the body. The male connector comprising an regular USB input port and/or a type C input port. The body further comprising a cable laying channel for the cable getting through the outer surface of the body to the inside of the body. And at least two exit on the body between the two ends of cable laying channel to let the male and female connector get through. An opening is provided on the cable laying channel of the body for convenient replacing the cable. Wherein the one way charging cable further comprising an external connecting cable having a male end, wherein the male end of the external cable is plugged into the output port of the female end of the cable female connector.

An one way charging cable for bag and luggage using for the purpose of safety use, comprising, a bag or luggage body, a cable with at least one male connector and one female connector, a sheath fixed on the body to receive the female connector of the cable, and retained above the outer surface of the body, wherein, the male connector in retained inside of the body, adjacent to a power source placing space, wherein, the female connector contained a master integrated circuit inside, controlling the charging port (female connector) to be a special one way charging, forming the cable for output non input function, to avoid the risk of overcharging and overheating of the power source inside of the body. The female connector comprising an regular USB output port and a type C output port. The integrated circuit inside of the female connector is further comprising a wireless module, configured to connecting with mobile phone to control and check the charging status, or tracking the bag or luggage.

Compared with the prior art, the present invention enjoys the following advantages 1) Through the creation points of the invention, change the two-way charging function of the regular charging cable to one-way charging function, to creating a new improved one way charging cable for the bag and luggage using, which is conducive to ensuring the safety of users, prevent charging through the charging cable installed on the bag or luggage, reducing the risk of overcharging the battery, or even explosion happen. 2) At the same time, the invention of creating a new kind of female end of cable, with an integrated circuit inside of the female connector, and comprising a wireless module, configured to connecting with mobile phone, to control and check the charging status, or tracking the bag or luggage.

### BRIEF DESCRIPTION OF THE DRAWINGS

The utility model is further described as follows with reference to drawings and embodiments:

FIG. 1 depicts aspects of the present invention;

FIG. 2 depicts aspects of the present invention;

FIG. 3 depicts aspects of the present invention;

FIG. 4 depicts aspects of the present invention;

FIG. 5 depicts aspects of the present invention;

FIG. 6 depicts aspects of the present invention;

FIG. 7 depicts aspects of the present invention;

FIG. 8 depicts aspects of the present invention;

FIG. 9 depicts aspects of the present invention;

FIG. 10 depicts aspects of the present invention;

FIG. 11 depicts aspects of the present invention;

FIG. 12 depicts aspects of the present invention;

FIG. 13 depicts aspects of the present invention;

FIG. 14 depicts aspects of the present invention;

FIG. 15 depicts aspects of the present invention;

FIG. 16 depicts aspects of the present invention;

FIG. 17 depicts aspects of the present invention;

FIG. 18 depicts aspects of the present invention;

FIG. 19 depicts aspects of the present invention;

FIG. 20 depicts aspects of the present invention;

FIG. 21 depicts aspects of the present invention;

FIG. 22 depicts aspects of the present invention;

FIG. 23 depicts aspects of the present invention;

FIG. 24 depicts aspects of the present invention;

FIG. 25 depicts aspects of the present invention;

FIG. 26 depicts aspects of the present invention;

FIG. 27 depicts aspects of the present invention;

FIG. 28 depicts aspects of the present invention;

FIG. 29 depicts aspects of the present invention.

### DETAILED DESCRIPTION OF THE EMBODIMENTS

The content of the utility model is further described in detail as follows with reference to the drawings for specification and specific embodiments.

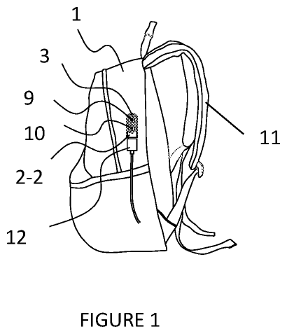

FIG. 1 shows embodiment 1 of the utility model, which is a backpack comprising the bag body 1, wherein, a placing space for placing an electrical storage device (which is not shown in the drawing) is provided inside the bag body 1, the bag further comprises an one way charging cable 2 on the bag body 1, and the male connector 2-1 of the cable 2 is connected to the power storage device in the power storage device placing space; the female connector 2-2 is exposed outside the opening, and the female connector 2-2 is in a sheath fixed on the body, and retained above the outer surface of the body sheath 3 for water proofing wrapped on the outer surface of the female connector 2-2; the male connector 2-2 is further contained a master integrated circuit inside, controlling the charging port to be a special one way charging, forming the cable for output non input function, to avoid the risk of overcharging and overheating of the power source inside of the body.

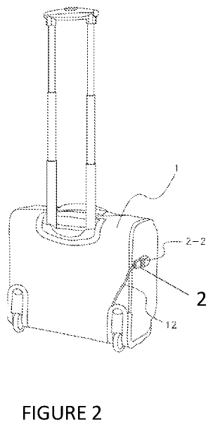

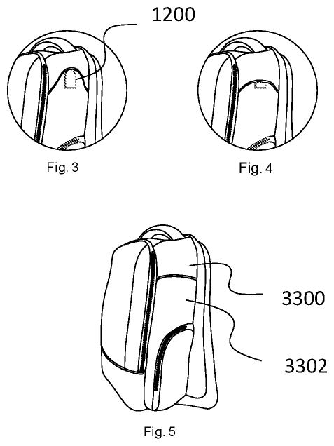

FIG. 2 shows embodiment 2, during traveling, when the power source/battery of the product to be charged is dying, it is only necessary to plug the external charging cable 12 to the female connector 2-2 of the one way charging cable 2, then the charging starts, without necessarily opening the bag or luggage, nor taking out the power source for charging.

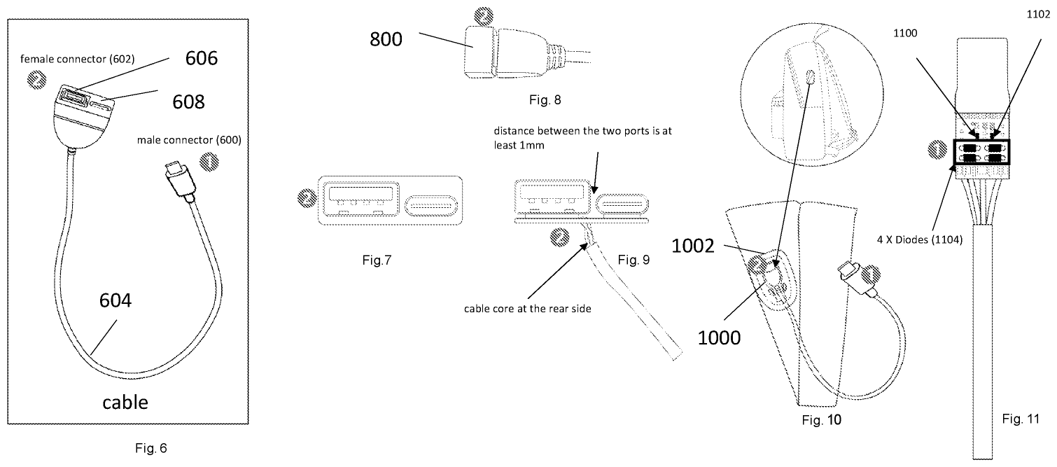

FIGS. 6, 7, 8, 9, 10, 11, 12, 13 and 14 depicts the one way charging cable with one Type-C male connector and two type of female connector.

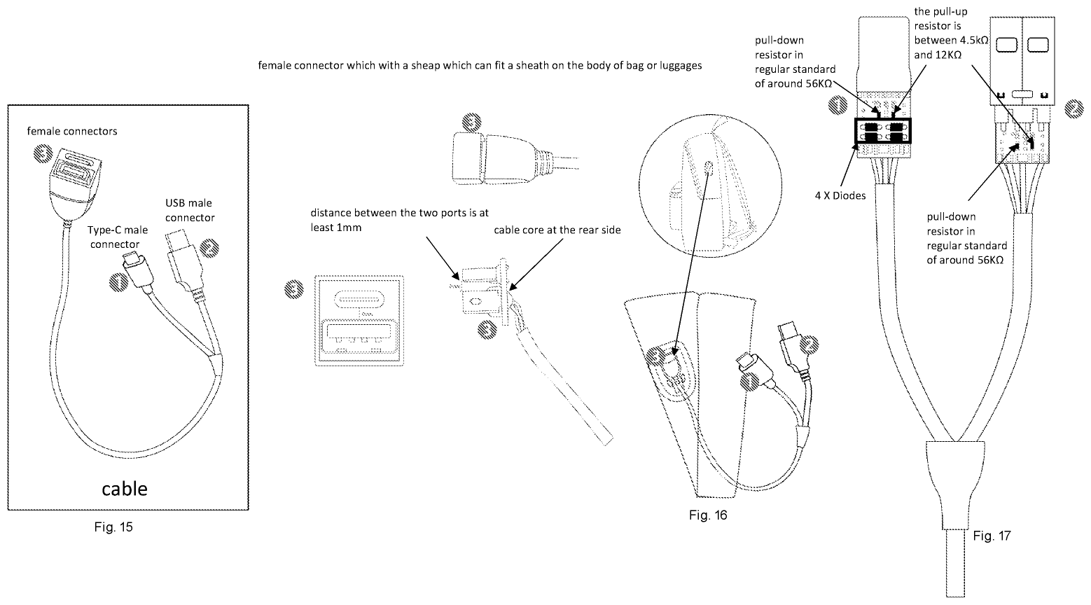

FIGS. 15, 16 and 17 depicts the one way cable with two type of male connectors and two type of female connector.

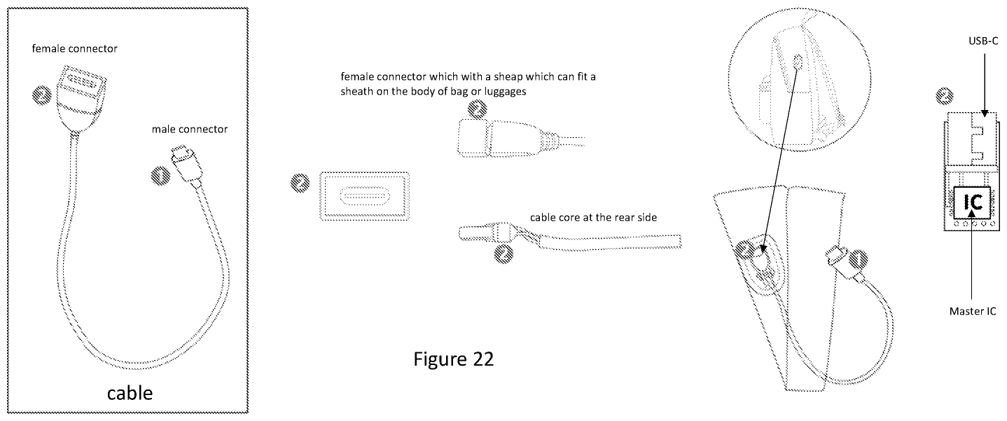

FIGS. 21 and 22 depicts the female connector contained a master integrated circuit inside, controlling the charging port to be a special one way charging, forming the cable for output non input function, to avoid the risk of overcharging and overheating of the power source inside of the body. And the integrated circuit inside of the female connector is further comprising a wireless module, configured to connecting with mobile phone to control and check the charging status, or tracking the bag or luggage.

The present invention provides a one way safety charging cable for bag and luggage having a bag or luggage body (1000), a cable (604) with at least one male connector (600) and at least one female connector (602), a sheath (1002) fixed on the body (1000) to receive the female connector (602) of the cable, and retained above the outer surface of the body (1000), wherein the male connector (600) is retained inside of the body adjacent to a power source placing space (e.g. 2306), wherein inside of the male connector there is a pull-down resistor (1100) in regular standard between 45-60 kΩ (around 56 KΩ) and a pull-up resistor (1102) between 4.5 kg and 12 KΩ, and at least 4 Diodes (1104), forming a special one way cable for output non input function to avoid the risk of overcharging and overheating of the power source inside of the body. The purpose of adding the 4× Diodes: Rectifier circuit, detection circuit, voltage regulation circuit, is so that all the current can not pass, so that the external charger can not charge-in through this cable. The female connector may have a regular USB output port (606) and a type C output port (608). As shown in FIGS. 6, 7, 8, and 9, the regular USB output port and the type C output port are settled in one female connector and their distance is at least 1 mm. It is critical that the distance is at least 1 mm so that the current can not pass through. As shown in FIG. 15, the male connector may be a regular USB input port (1500) and a type C input port (1502). FIG. 15 depicts a stacked female connector configuration (regular USB port on the bottom and type C port on the top in a single unit) and a split male connector.

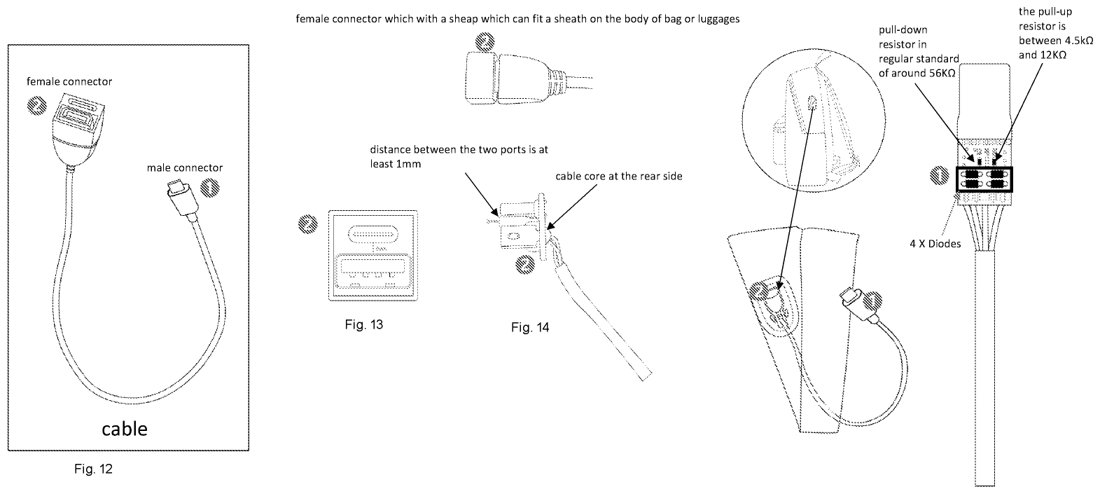

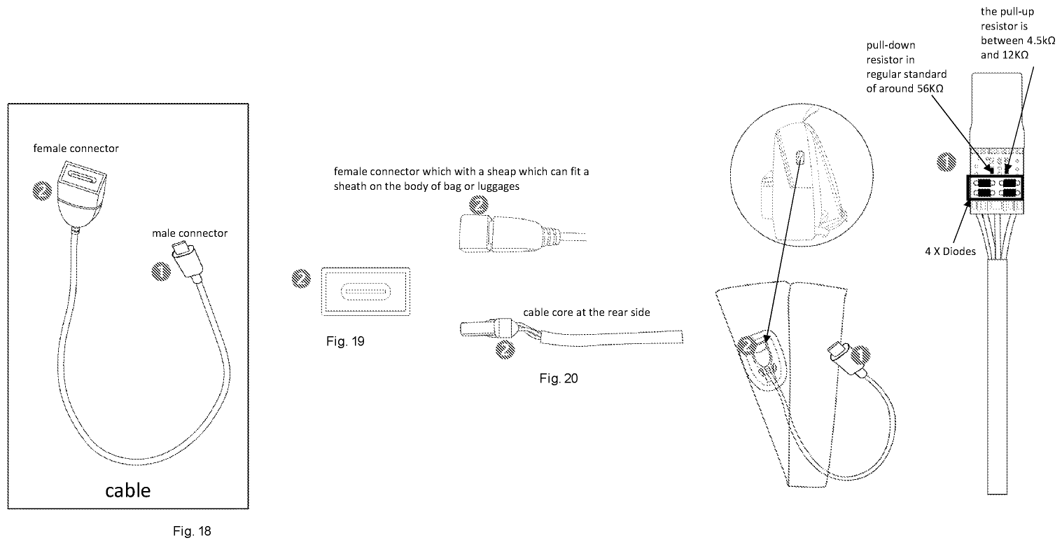

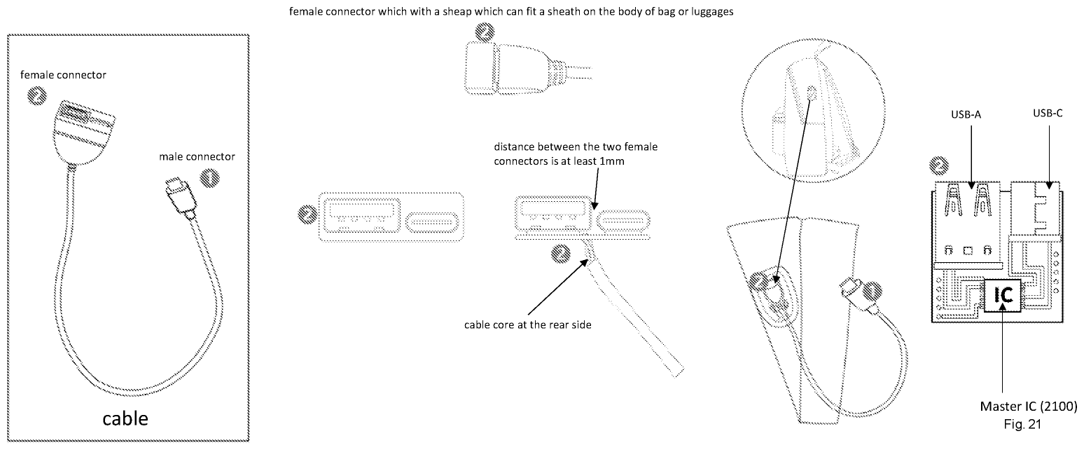

FIGS. 6, 7, 8, 9, 10 and 11 depict a Cable with one Type-C male connector and two types of female connector (one way charging). FIGS. 12, 13 and 14 depicts a cable with one Type-C male connector and two types of female connectors (one way charging). FIGS. 15, 16 and 17 depict a cable with two types of male connectors and two types of female connectors (one way charging). FIGS. 18, 19 and 20 depict a cable with type C male connectors and type C female connectors (one way charging). The female connector (602) is in a shape and size matching the sheath on the body. This is to say the female connector may be slightly smaller than the sheath and can fit inside of the sheath which then attaches the female connector to the luggage body. As can be seen in FIG. 10, the female connector may sit inside the sheath and may be in communication with or above the outer surface of the body (1000).

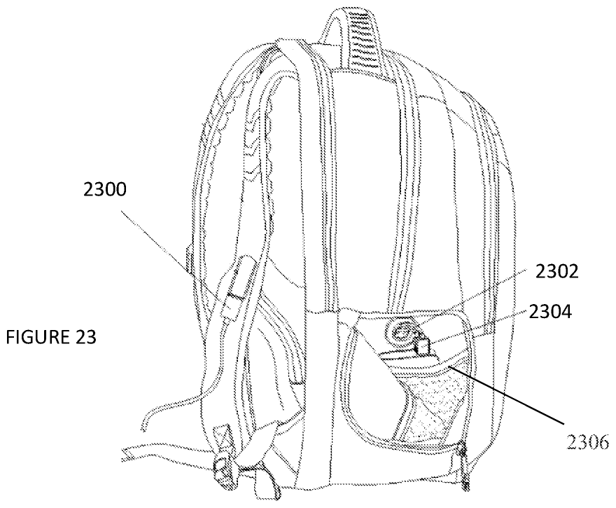

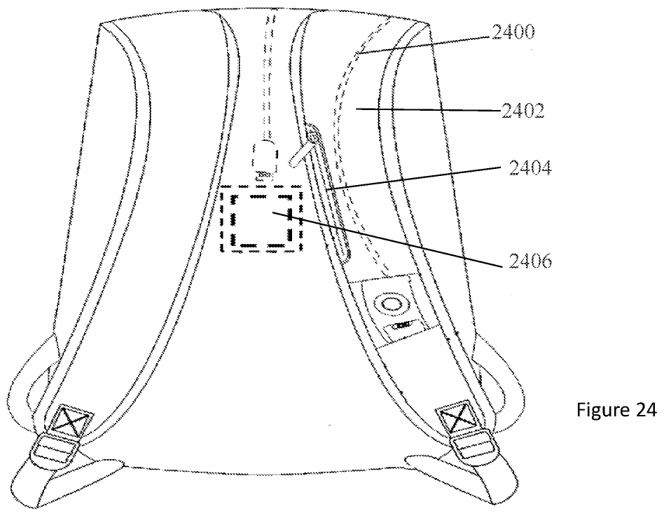

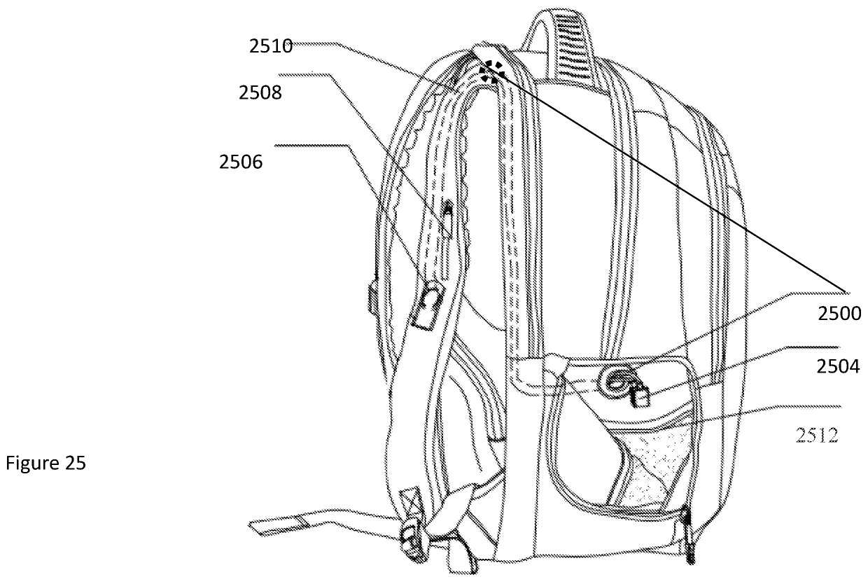

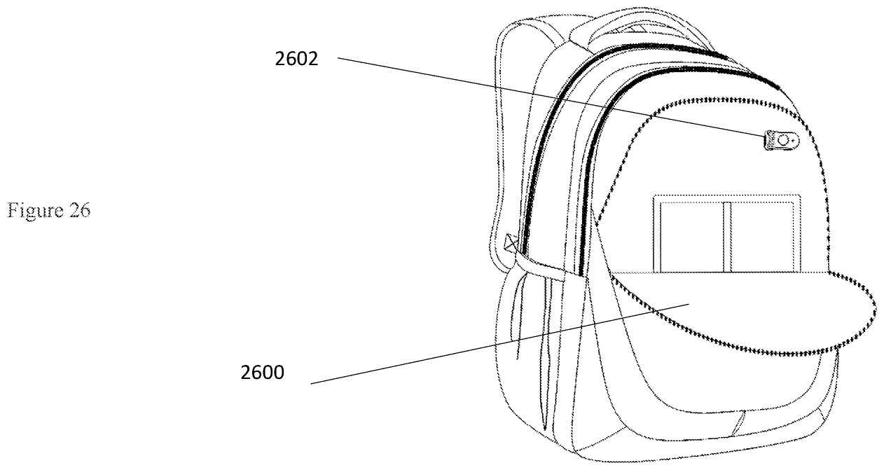

As shown in FIGS. 23, 24, 25 and 26, the body may have a cable laying channel for the cable getting through the outer surface of the body to the inside of the body. The external cable (2300) is plugged into the output port of the female end of the cable female connector. The cable (2302) with the male connector (2304) plugged into a power source in a power source placing space (2306). The power source placing space (2306) as shown is a pocket to hold a battery or a power bank. There may be at least two exits (2500) on the body (2502) between the two ends of cable laying channel to let the male connector (2504) and female connector (2506) get through. There may also be an opening (2404) that is provided on the cable laying channel of the body for convenient replacement of the cable (2400). There may be a channel closing or opening accessory (e.g. zipper) provided on the opening (2404) of the cable laying channel. There may also be an external connecting cable having a male end, wherein the male end of the external cable is plugged into the output port of the female end of the cable female connector. There may be a second outer surface (2600) that covers the outer surface of the body. In this way there may be an outer pocket that can hold and protect the device to be charged and the protect the sheath (2602). In this case the outer surface of the body is the inside of the pocket.

A one way safety charging cable for bag and luggage, comprising, a bag or luggage body, a cable with at least one male connector and one female connector, a sheath fixed on the body to receive the female connector of the cable, and retained above the outer surface of the body, wherein the male connector is retained inside of the body, adjacent to a power source placing space, wherein the female connector is contained a master integrated circuit (2100) inside, controlling the charging port (female connector) to be a special one way charging, forming the cable for output non input function, to avoid the risk of overcharging and overheating of the power source inside of the body. The integrated circuit is equipped with a current-sensing sensor, which manages the current output to the female connector only, and sends a command to disconnect the current connection as soon as there is current input to the male connector.

According to one embodiment, the female connector is a regular USB output port and a type C output port (e.g. 602). According to some embodiments (as shown in FIGS. 6, 7, 8 and 9 by way of example), the regular USB output port and the type C output port are settled in one female connector, and their distance is at least 1 mm. The distance is critical to prevent the current from passing through. This is the distance to make the user can use two external cable to connect the both USB and Type C female connector to charge their two device at the same time, because the external cable connector with thickness, to have two together will need some distance.

The female connector is in a shape and size that matches the sheath on the body. The female connector may have a shape (300, 800) which may be a plastic wrap, cover or a case surrounding the female connectors to contain and protect them, while allowing them to sit inside the sheath. FIG. 10 depicts the female connector (1000) sitting inside the sheath (1002) from a bottom view. The sheath may also have a bottom surround portion (1650) that allows the sheath to be attached to the body and maintain the female connector above the outer surface of the body. This is important as it allows the female connector to be easy to plug into as it is above the outer surface of the body.

The integrated circuit (2100) inside of the female connector may be a wireless module, configured to connect with a mobile phone to control and check the charging status, or to track the bag or luggage. The wireless module may be is a Bluetooth module.

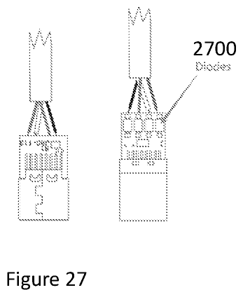

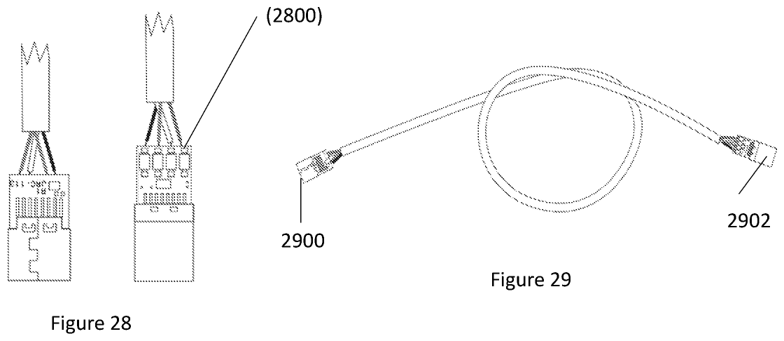

FIGS. 27, 28 and 29 depicts male connector with a regular USB end (2900) and a type C connector end (2902). The design concept of this TYPE-C charging protection cable is to make it more safe and reliable for consumers to use. A unidirectional transistor (2800) is added to the TYPE-C male to prevent power bank explosions caused by mismatched chargers charging the power bank. At the same time, the reasonable layout of unidirectional transistors also ensures stability during the conduction process of the extension line. The wire of this product may be made of TPE material, which is resistant to bending; Soft and silky to the touch, not prone to overheating.

The specific embodiments above are only detailed explanation on the technical solutions of the utility model, and the utility model is not limited only by the embodiments above. Any improvement or replacement based on the principle of the utility model shall be within the protection scope defined in claims of the utility model.

1. A one way safety charging cable for bag and luggage, comprising,
a bag or luggage body,
a cable with at least one male connector and at least one female connector,
a sheath fixed on the body to receive the female connector of the cable, and retained above the outer surface of the body,
wherein the male connector is retained inside of the body adjacent to a power source placing space,
wherein inside of the male connector there is a pull-down resistor in regular standard between 45-60 kW and a pull-up resistor between 4.5 kΩ and 12 KΩ, and at least 4 Diodes.

2. A one way safety charging cable for bag and luggage as in claim 1, the female connector comprising a regular USB output port and a type C output port.

3. A one way safety charging cable for bag and luggage as in claim 2, the regular USB output port and the type C output port are settled in one female connector and the distance between the regular USB output port and the type C output port is at least 1 mm.

4. A one way safety charging cable for bag and luggage as in claim 1, wherein the female connector is in a shape and size matching the sheath on the body.

5. A one way safety charging cable for bag and luggage as in claim 1, the male connector comprising an regular USB input port and a type C input port.

6. A one way safety charging cable for bag and luggage as in claim 1, the body further comprising a cable laying channel for the cable getting through the outer surface of the body to the inside of the body.

7. A one way safety charging cable for bag and luggage as in claim 6, wherein the female connector has four diodes.

8. A one way safety charging cable for bag and luggage as in claim 6, wherein an opening is provided on the cable laying channel of the body for convenient replacing the cable.

9. A one way safety charging cable for bag and luggage as in claim 6, wherein a channel closing or opening accessory provided on the opening of the cable laying channel.

10. A one way safety charging cable for bag and luggage as in claim 1, wherein further comprising an external connecting cable having a male end, wherein the male end of the external cable is plugged into the output port of the female end of the cable female connector.

11. A one way safety charging cable for bag and luggage as in claim 1, further comprising a second outer surface that covers the outer surface of the body.

12. A one way safety charging cable for bag and luggage as in claim 1, wherein the outer surface of the body is the inside of a pocket.

13. A one way safety charging cable for bag and luggage, comprising,
a bag or luggage body,
a cable with at least one male connector and at least one female connector,
a sheath fixed on the body to receive the female connector of the cable, and retained above the outer surface of the body,
wherein the male connector is retained inside of the body, adjacent to a power source placing space,
wherein the female connector is on a master integrated circuit controlling the female connector to be one way charging.

14. A one way safety charging cable for bag and luggage as in claim 13, the female connector comprising an regular USB output port and a type C output port.

15. A one way safety charging cable for bag and luggage as in claim 13, the regular USB output port and the type C output port are settled in one female connector, and their distance is at least 1 mm.

16. A one way safety charging cable for bag and luggage as in claim 13, wherein the female connector is in a shape and sizes matching the sheath on the body.

17. A one way safety charging cable for bag and luggage as in claim 13, the male connector comprising an regular USB input port and a type C input port.

18. A one way safety charging cable for bag and luggage as in claim 13, the body further comprising a cable laying channel for the cable getting through the outer surface of the body to the inside of the body.

19. A one way safety charging cable for bag and luggage as in claim 13, wherein at least two exit on the body between the two ends of cable laying channel to let the male and female connector get through.

20. A one way safety charging cable for bag and luggage as in claim 13, wherein an opening is provided on the cable laying channel of the body for convenient replacing the cable.

21. A one way safety charging cable for bag and luggage as in claim 13, wherein a channel closing or opening accessory provided on the opening of the cable laying channel.

22. A one way safety charging cable for bag and luggage as in claim 13, wherein further comprising an external connecting cable having a male end, wherein the male end of the external cable is plugged into the output port of the female end of the cable female connector.

23. A one way safety charging cable for bag and luggage as in claim 13, further comprising a second outer surface that covers the outer surface of the body.

24. A one way safety charging cable for bag and luggage as in claim 13, wherein the outer surface of the body is the inside of a pocket.

25. A one way safety charging cable for bag and luggage as in claim 13, wherein the integrated circuit inside of the female connector is further comprising a wireless module, configured to connecting with mobile phone, (in spec: it to control and check the charging status, or tracking the bag or luggage)

26. A one way safety charging cable for bag and luggage as in claim 13, wherein the wireless module is a Bluetooth module.

27. A one way safety charging cable for bag and luggage, comprising,
a bag or luggage body,
a cable with at least one male connector and at least one female connector,
a sheath fixed on the body to receive the female connector of the cable, and retained above the outer surface of the body,
wherein the male connector is retained inside of the body adjacent to a power source placing space,
wherein inside of the male connector there is at least one Diode.

28. A one way safety charging cable for bag and luggage as in claim 27, wherein the male connector is further comprising at least one unidirectional transistor.
